(19) United States
(12) Patent Application Publication
(10) Pub. No.: US 2016/0175068 A1
(43) Pub. Date: Jun. 23, 2016

(54) DIRECT FRACTIONAL STEP METHOD FOR GENERATING TOOTH ARRANGEMENT

(71) Applicant: Shanghai Hui Yin Information Technology Co., Ltd, Shanghai (CN)

(72) Inventors: Ning Cai, Shanghai (CN); Xiaoliang Li, Shanghai (CN)

(21) Appl. No.: 14/973,738

(22) Filed: Dec. 18, 2015

(30) Foreign Application Priority Data
Dec. 23, 2014 (CN) 201410831582.8

(51) Int. Cl. A61C 7/00; G06F 17/50; G06F 17/16; A61C 7/08

(52) U.S. Cl. CPC A61C 7/002; A61C 7/08; G06F 17/5009; G06F 17/16

(57) ABSTRACT

A method for generating tooth arrangements is provided. The method includes: receiving a digital model representing an initial tooth arrangement; determining K orthodontic treatment step parameters, wherein the orthodontic treatment step parameters represent the number of orthodontic treatment steps for moving the initial tooth arrangement to an expected tooth arrangement, and K is an integer greater than or equal to 1; for each orthodontic treatment step parameter, generating a group of digital models representing a tooth arrangement set corresponding to the orthodontic treatment step parameter, thereby obtaining K groups of digital models; and selecting one group from the K groups of digital models that represents a best tooth arrangement set. A method for manufacturing a dental appliance based on the obtained tooth arrangement and the dental appliance manufactured according to the method are also provided.

### CROSS-REFERENCE TO RELATED APPLICATIONS

This application claims priority to Chinese Patent Application No. 201410831582.8 filed on Dec. 23, 2014, which is incorporated herein by reference in its entirety.

### TECHNICAL FIELD

The present disclosure is related to orthodontic treatment, particularly to a method for generating a series of tooth arrangements. In addition, the present disclosure is also related to a method for manufacturing dental appliances based on the generated tooth arrangements and dental appliances manufactured by such method.

### BACKGROUND

Dento-maxillofacial deformity, as one of three main dental diseases, has a high prevalence rate. Conventional treatments on dento-maxillofacial deformity often use braces applied to the teeth of a patient. A drawback of the conventional treatments is that the exposure of the brace will affect the appearance. In addition, dental hygiene can not be well maintained due to long term adhesion of the appliances to the teeth, since the appliances cannot be removed during the treatment. Therefore, plaques may easily breed on the appliances, which causes teeth demineralization and discoloration. Moreover, a clinician must manually adjust the appliances regularly during the treatment. The treatment is complicated and time consuming. In addition, the effect of the treatment mainly depends on the skill of the clinician. Compared with conventional treatments using braces, a new invisible orthodontic treatment does not require brackets and wires, instead it uses a series of invisible appliances (i.e. clear appliances) made of safe elastic transparent polymer materials. Therefore, the invisible orthodontic treatment is almost unnoticeable, and will not affect daily life or social activity. Patients may take on or off the invisible appliances by themselves, therefore the dental hygiene can be maintained normally. Moreover, since the complicated steps of brace attachment and wire adjustment are not required, clinical operation is significantly simplified, and a great amount of time and labor could be saved. Thanks to the aforementioned advantages, the invisible orthodontic treatment is more and more popular.

In conventional invisible dental appliances designs, an image of an initial tooth arrangement of a patient is first collected and a final tooth arrangement is determined by a clinician based on the initial tooth arrangement. A computer aided design is then used to interpolate linearly or non-linearly between the initial tooth arrangement and the final tooth arrangement to generate a plurality of intermediate tooth arrangements for manufacturing a series of invisible dental appliances. Although it is an intuitive method to generate intermediate positions based on the initial position and the target position, this method separates the target position and the intermediate positions, and cannot achieve overall optimization. Moreover, after the target position is determined, the interpolation method is used to calculate the intermediate positions. The interpolation method cannot ensure optimization of the resultant path from the initial tooth arrangement to the final tooth arrangement. The final position may be achieved through less intermediate positions. Furthermore, the predefined final position may not be a position that is medically achievable or reasonably achievable, which makes it impossible or difficult to be implemented medically.

Therefore, a method that is both effective and flexible in designing invisible dental appliances is needed.

### SUMMARY

A method for determining a target tooth arrangement is provided in the present disclosure. The method is closely related with actual requirement on orthodontic treatment, and can generate an optimal tooth arrangement through minimal movement steps based on a target of the orthodontic treatment, thereby to design and manufacture the corresponding invisible dental appliances.

According to an aspect of the present disclosure, a method for generating tooth arrangements is provided. The method includes: receiving a digital model representing an initial tooth arrangement; determining K orthodontic treatment step parameters, wherein the orthodontic treatment step parameters represent the number of orthodontic treatment steps for moving the initial tooth arrangement to an expected tooth arrangement, and K is an integer greater than or equal to 1; for each orthodontic treatment step parameter, generating a group of digital models representing a tooth arrangement set corresponding to the orthodontic treatment step parameter, thereby obtaining K groups of digital models; and selecting one group from the K groups of digital models that represents a best tooth arrangement set.

Each tooth arrangement set corresponding to an orthodontic treatment step parameter includes a target tooth arrangement and a plurality of intermediate tooth arrangements progressively changing into the target tooth arrangement, and the number of the plurality of intermediate tooth arrangements included in each tooth arrangement set is determined by the corresponding orthodontic treatment step parameter.

In another specific embodiment, each tooth arrangement set corresponding to an orthodontic treatment step parameter includes a plurality of intermediate tooth arrangements progressively changing into the target tooth arrangement, and the number of the plurality of intermediate tooth arrangements included in each tooth arrangement set is determined by the corresponding orthodontic treatment step parameter.

Moreover, optionally, for each orthodontic treatment step parameter, the digital models representing the tooth arrangement set corresponding to the orthodontic treatment step parameter are generated based on a multi-objective optimization model.

The digital models representing the tooth arrangement set corresponding to the orthodontic treatment step parameter are generated by converting the multi-objective optimization model into a single-objective optimization model.

Moreover, the multi-objective optimization model is created based on one or more selected from the following medical parameters: curve of dental arch, degree of dental crowding, amount of interproximal reduction, overjet, overbite, dental arch convexity, depth of curve of Spee, Bolton ratio, dental arch width, arch symmetry, degree of tooth torsion, angulation of crown, torque, midline and profile of facial soft issue. The medical parameters are elaborated as follows.

1. Curve of dental arch: Teeth sit on the gum in an arch shape along the alveolar bone. The arch curve that connects all teeth of the upper jaw is called as the maxillary curve of dental arch, and the arch curve that connects all teeth of the lower jaw is called the mandible curve of dental arch.

2. Degree of dental crowding: The degree of dental crowding is defined as the difference between the sum of crown widths and the length of the initial arch. A positive value indicates that crowding exists in the dental arch. A negative value indicates that a gap exists in the dental arch. A zero value indicates that neither crowding nor gap exists. The crown width refers to the mesio-distal width of the crown. The length of the initial lower arch is the overall arc length of the dental arch. The arc length of the initial dental arch is the length of an arc that starts from the mesial contact point of the first molar of lower jaw, crossing the buccal cusp of premolars of the lower jaw, cusps of the lower cuspid, edges of lower incisors, and ends at the mesial contact point of the first molar of upper jaw on the opposite side. If all lower incisors incline to the labial side or lingual side, the arc should be measured along the ridge roof of the lower incisor. The same goes for the measurement of initial upper arch length. In a normal tooth arrangement, the degree of dental crowding should be zero. However, a range may be set for a patient, and if the amount of crowding falls into that range, the tooth arrangement is considered to meet the requirement on this parameter.

3. Amount of interproximal reduction (IPR): IPR is one of the methods for resolving dental crowding. By slightly polishing and shaping of the adjacent faces of a plurality of teeth, the contact relationship between closely adjacent teeth in the dentition disappears, and gaps between teeth are formed. The amount of interproximal reduction reflects the degree of interproximal reduction.

4. Overjet: Overjet is also called anterior overjet and refers to the horizontal distance between the upper incisor edge and the labial surface of the lower incisor. A normal overjet is usually from about 2 mm to about 4 mm.

5. Overbite: Overbite is also called anterior overbite and refers to the distance between the upper incisor edge point and the foot of the perpendicular of the perpendicular line drew from the upper incisor edge point to the labial surface of the lower incisor. In a normal tooth arrangement, anterior overbite should be less than ⅓ of the labial surface of the lower anterior teeth.

6. Dental arch convexity: The dental arch convexity is generally represented by the specific positions of incisors. It can be obtained by cephalometric measurement. The gap may be occupied when the dental arch convexity is decreased, and otherwise, the gap may be formed. A mean value of the arch convexity of lower incisor of Chinese people is generally 96.5°±7.1.

7. Degree of Spee curve: It is defined as a continuous longitudinally concave occlusion curve connecting ridges of the lower incisors and cusps of the other teeth. It is also called as Spee curve. The method to measure the degree of Spee curve of dental arches on both sides is to measure the distance between the lowest point of the occlusal plane of the dental arch and the plane formed by the lower incisor end and the cusp of the last lower molar. Generally, the normal depth of Spee curve is about 2 mm. The gap is needed to level the Spee curve. The gap needed is calculated as follows: measuring the degree of Spee curves of left side and right side separately, dividing the result by 2 and the resulting value is the gap needed to level the dental arch or correct the occlusal curve.

8. Bolton index: Bolton index reflects the ratio between the sum of crown width of upper anterior teeth and that of the lower anterior teeth, and the ratio between sum of crown width of all teeth of the upper dental arch and that of the lower dental arch. Bolton index may be used to diagnose if the patient's upper and lower dental arches do not match with each other in the crown width. The following ratios are obtained by measuring the crown width of the upper and lower jaws:

anterior ratio=sum of crown width of 6 anterior teeth of lower jaw/sum of crown width of 6 anterior teeth of upper jaw*100%

overall ratio=sum of crown width of 12 anterior teeth of lower jaw/sum of crown width of 12 anterior teeth of upper jaw*100%

Normal Bolton Index (Bolton, 1958) are:

anterior ratio: (77.2±0.22)%

overall ratio: (91.3±0.26)%

Normal Bolton Index of Chinese:

anterior ratio: (78.8±1.72)%

overall ratio: (91.5±1.51)%

According to the above ratios, it can be determined whether the incoordination is in the upper arch or in the lower arch, and whether the width abnormality is in anterior teeth or in all teeth.

9. Dental arch width: Generally, dental arch widths are measured with three sections, including the width between cuspids, the width between bicuspids, and the width between molars, respectively.

(1) Width between cuspids represents the width of anterior section of the dental arch. It can be obtained by measuring the distance between the cusps of cuspids on both sides.

(2) Width between bicuspids represents the width of middle section of the dental arch. It can be obtained by measuring the distance between the central fossa of first bicuspids.

(3) Width between molars represents the width of posterior section of the dental arch. It can be obtained by measuring the distance between the central fossa of first permanent molars.

10. Arch symmetry: It may be determined whether the left side and right side of the dental arch is symmetrical and whether the same teeth on both sides are on the same plane in the anterior-posterior direction by drawing a line along the mid-palatal raphe on the upper jaw model as a reference midline and then measuring the distance to the midline from the same teeth on both sides. If the same teeth on both sides are not on the same plane in the anterior-posterior direction, it indicates that the tooth on one side is moved anteriorly.

11. Degree of tooth torsion: Generally, an angle between a tangent line of a clinical dental arch and a dental axis is the torsion angle. When a tooth is seriously twisted, it affects negatively on appearance and is harmful to chewing function.

12. Degree of dental axis inclination: An angle formed by the long axis of the clinic crown of a tooth and the perpendicular line of the occlusal plane is the angle of dental axis inclination. The degree of dental axis inclination is positive when the gingival end of the long axis of the clinic crown inclines distally, and is negative when the gingival end of the long axis of the clinic crown inclines mesially. Most of the degrees of dental axis inclination of normal occlusion are positive.

13. Teeth torque: An angle formed by the tangent line of the clinic crown of teeth and the perpendicular line of the occlusal plane is called the teeth torque. The teeth torque is positive when the gingival end of the clinic crown is behind the perpendicular line of the occlusal plane, and is negative otherwise.

14. Dental midline: The dental midline is a virtual line crossing between two incisors of the upper jaw or the lower jaw. It indicates that the midline of the upper dentition and the midline of the lower dentition are consistent if the upper line and the lower line overlap. If the upper line and the lower line do not overlap, then the difference between than is the amount of inclination of the midlines of the upper and the lower dentitions.

15. Shape of facial soft tissues: The shapes of the upper and the lower lips of a face, the nasolabial angle, and the facial profile are examples of shape of facial soft tissues.

Further, the multi-objective optimization model is created based on one or more selected from orthodontic treatment constraints. The Further, the multi-objective optimization model is created based on one or more selected from orthodontic treatment constraints include various medical and technological constraints required to be considered during the treatment. For example, the orthodontic treatment constraints include: direction and amount of tooth movement in each orthodontic treatment step, a sum of tooth forces in each orthodontic treatment step, limitation on freedom of tooth movements and requirements for avoiding teeth collision, direction and amount of midline adjustment, biting relationship of the upper and lower jaws. The orthodontic treatment constraints are illustrated below in detail.

1) The direction and amount of teeth movement in each orthodontic treatment step is the direction and amount of movement of each tooth at each orthodontic treatment step. Specifically, it includes the following: amount of translation along the X axis, amount of translation along the Y axis, amount of translation along the Z axis, rotation angle about the X axis, rotation angle about the Y axis, rotation angle about the Z axis. The aforementioned amount of movement is restricted by medical constraints, for example, the amount of translation along the X, Y and Z axes cannot exceed 2 mm or are reasonably defined by an operator according to a patient's actual condition. The rotation angles about the X axis, Y axis and Z axis cannot exceed 5 degrees or are reasonably defined by an operator according to a patient's actual condition.

2) The sum of forces of teeth in each orthodontic treatment step is the sum of forces applied to each tooth in each orthodontic treatment step. The constraints are used to ensure that forces exerted by the dental appliance manufactured according to the present disclosure may not exceed an acceptable level of orthodontic treatment and the uncomfortableness of the patient does not exceed an acceptable amount.

3) The range of degree of freedom of teeth include 6 aspects as follows: (1) restricted range in faciolingual direction; (2) restricted range in mesial-distal direction; (3) restricted range in vertical direction; (4) restricted range in torsion; (5) restricted range in positive axis; (6) restricted range in torque.

The aforementioned restricted range in faciolingual direction further includes movement range of upper anterior teeth in faciolingual direction, movement range of upper posterior teeth in facioligual direction, movement range of lower anterior teeth and movement range of lower posterior teeth in facioligual direction. The movement range of upper anterior teeth may be defined as no movement, movement toward lip/movement toward tongue <3 mm or reasonably defined by an operator according to the patient's actual condition. The movement range of upper posterior teeth may be defined as no movement, movement toward cheek/movement toward tongue <2 mm or reasonably defined by an operator according to the patient's actual condition. The movement range of lower anterior teeth may be defined as no movement, movement toward lip/movement toward tongue <3 mm or reasonably defined by an operator according to the patient's actual condition. The movement range of upper posterior teeth may be defined as no movement, movement toward cheek/movement toward tongue <2 mm or reasonably defined by an operator according to the patient's actual condition.

The restricted range in mesial-distal direction may be defined as <3 mm or reasonably defined by an operator according to the patient's actual condition.

The restricted range in vertical direction includes the movement range of the upper anterior teeth in the vertical direction, the movement range of the upper posterior teeth in the vertical direction, the movement range of the lower anterior teeth in the vertical direction and the movement range of the lower the posterior teeth in the vertical direction. The movement range of the upper anterior teeth in the vertical direction, the movement range of the upper posterior teeth in the vertical direction, the movement range of the lower anterior teeth in the vertical direction and the movement range of the lower posterior teeth in the vertical direction may be separately defined, and any one of the four parameters may be defined as no movement, eruption/intrusion <2 mm or reasonably defined by an operator according to the patient's actual condition.

The aforementioned restricted range of torsion, positive axis and the restricted range of torque may be separately defined, and any one of the three parameters may be defined as adjustment based on standard data, no correction or reasonably defined by an operator according to the patient's actual condition. In some embodiments, the restricted range of torsion, positive axis and torque are all defined as <0.

4) The requirements for avoiding teeth collision indicate to avoid collision between two teeth of the same jaw during a tooth alignment process using a computer. That is, a minimum distance between any two teeth should be greater than zero.

According to an embodiment of the present disclosure, each of the above medical parameters and orthodontic treatment constraints may be set by an operator through a computer graphical interface. The set medical parameters and the orthodontic treatment constraints can be combined and then applied to the dental model.

Optionally, the orthodontic treatment constraints include inequality constraints and equality constraints.

When the multi-objective or single-objective optimization model is created, a global optimization algorithm is optionally used to calculate an optimal solution to an objective function of a tooth arrangement set that corresponds to each orthodontic treatment step parameter to generate the digital models representing the tooth arrangement set that corresponds to each orthodontic treatment step parameter. In an exemplary embodiment, the global optimization algorithm includes a simulated annealing algorithm.

Further, according to an embodiment, for each orthodontic treatment step parameter, the optimal solution to the objective function calculated using the global optimization algorithm is determined as an objective function value corresponding to the orthodontic treatment step parameter.

Moreover, the method may further include: generating a graph that represents a correspondence between the determined objective function value and the orthodontic treatment step parameters. The method further include: presenting the graph to a user such that the user may choose the best tooth arrangement set based on the graph.

Optionally, the graph is a curve graph. The method further includes: calculating an inflection point of the curve graph and determining a tooth arrangement set corresponding to the inflection point as the best tooth arrangement set.

According to another embodiment, the method further includes: after obtaining the K groups of digital models, presenting to a user an image of the target tooth arrangement included in each tooth arrangement set.

According to still another embodiment, the method further includes: after obtaining the K groups of digital models, presenting to a user an image of the intermediate tooth arrangements and target tooth arrangement included in each tooth arrangement set.

The best tooth arrangement set may be chosen from either a tooth arrangement set that has an optimal target tooth arrangement, or a tooth arrangement set that is optimal based on a balanced consideration of the target tooth arrangement and orthodontic treatment step parameter. Alternatively, the best tooth arrangement set may be chosen from either a tooth arrangement set that is optimal based on a balanced consideration of the target tooth arrangement and orthodontic treatment step parameter, or a tooth arrangement set that is optimal based on a balanced consideration of the intermediate tooth arrangements, target tooth arrangement and orthodontic treatment step parameter. The best tooth arrangement may also be chosen by a user or a computer.

According to another aspect of the present disclosure, a method for manufacturing dental appliances is provided, which includes: obtaining the best tooth arrangement set of a patient according to the above methods, and manufacturing the dental appliances using digital models of the best tooth arrangement set.

Moreover, in an embodiment, after obtaining the digital models of the best tooth arrangement set, the method further includes: executing a post-processing step for the digital models of the best tooth arrangement set to append one or more of the following: a digital attachment, a digital undercut and a digital label.

In an embodiment, the digital models of the best tooth arrangement set are transmitted to a dental appliance manufacturing device, and the dental appliance manufacturing device utilizes the digital models to generate male molds for manufacturing dental appliances having corresponding shapes.

Alternatively, the male molds are generated by the dental appliance manufacturing device using a rapid prototyping process.

Moreover, according to another embodiment, the digital models of the dental appliances are determined based on the digital models of the best tooth arrangement set, and the digital models of the dental appliance are transmitted to a dental appliance manufacturing device, and the dental appliances are directly manufactured by the dental appliance manufacturing device based on the digital models of the dental appliances.

According to still another aspect of the present disclosure, a dental appliance manufactured by the above methods of manufacturing a dental appliance is provided.

Alternatively, the dental appliance is made from flexible high molecular material. The high molecular material is transparent flexible macromolecular material or macromolecular polymer material.

With the methods provided in the present disclosure, the target tooth arrangements in each tooth arrangement set may be automatically generated, thereby reducing subjectivity and error caused by manual setting of target tooth arrangement (or position) and improving efficiency of the tooth alignment process.

Further, when generating the target tooth arrangement, intermediate tooth arrangements capable of progressing to the target tooth arrangement are considered, thereby the target tooth arrangement is achievable and can be achieved with minimum steps.

Finally, the present disclosure also provides an optimized combination for a clinician or a patient when selecting the target tooth arrangement and orthodontic treatment steps, which well balances between the effect of orthodontic treatment and time/cost of orthodontic treatment, thereby making the treatment scheme more reasonable.

### BRIEF DESCRIPTION OF THE DRAWINGS

Above and other features of the present disclosure will be further described below in combination with the drawings and their detailed illustration. It should be understood that the drawings merely illustrates some exemplary embodiments of the present disclosure and should not be regarded as limitations to the protection scope of the present disclosure. Without otherwise stated, the drawings are not necessarily proportional and similar labels in the drawings represents similar components.

FIG. 1 illustrates a flowchart of a method for generating tooth arrangements according to an embodiment of the present disclosure.

FIG. 2 illustrates a single tooth according to an embodiment of the present disclosure.

FIG. 3 illustrates a diagram of teeth positions according to an embodiment of the present disclosure.

FIG. 4 illustrates an initial curve of dental arch according to an embodiment of the present disclosure.

FIG. 5 illustrate a target curve of dental arch according to an embodiment of the present disclosure.

FIG. 6 illustrates a flowchart of an optimal algorithm for obtaining tooth arrangements according to an exemplary embodiment of the present disclosure.

FIG. 7 illustrates a curve graph of a correspondence between an orthodontic treatment step parameter and an objective function value according to an embodiment of the present disclosure.

FIG. 8 illustrates images of target tooth arrangements corresponding to different orthodontic treatment step parameters according to an embodiment of the present disclosure.

FIG. 9 illustrates an exemplary process of manufacturing an invisible dental appliance according to the present disclosure.

### DETAILED DESCRIPTION

The aforementioned features and other features of the present disclosure will be further described in the following paragraphs by referring to the accompanying drawings. The specification and accompanying drawings are merely used for illustration purpose and should not be considered as limitation to the scope of the present disclosure. It is understood for a person in the art that many other embodiments may be used and variations may be made on the embodiments described above without departing from the spirit and protection scope of the present disclosure. In should be understood that, various aspects of the present disclosure described and illustrated herein may be arranged, replaced, combined, separated or designed by many different configurations, and all these configurations are included in the present disclosure.

A method for generating tooth arrangements, a method for manufacturing dental appliances and a dental appliance manufactured thereby are provided in the present disclosure. The dental appliance disclosed in the present disclosure includes a series of shell-shaped polymers which, when sequentially applied to a patient's teeth, may progressively change the teeth status (such as the teeth positions) by elastic forces, such that the patient's teeth progressively align and achieve requirements on clinical standard and/or the patient's own requirement on appearance.

Generally, depending on the patients' initial tooth arrangement, a total of 25 to 40 dental appliances may be needed for a course of clinic treatment. The patient may generally wear a dental appliance for 1 to 2 weeks, and then wear a subsequent one. The patient's initial tooth arrangement (i.e., the tooth arrangement before treatment) will be progressively changed to an expected tooth arrangement (a target tooth arrangement) by elastic forces of the dental appliances. Therefore, each group of dental appliances corresponds to a group of tooth arrangements. In particular, the shape of the first dental appliance corresponds to the first tooth arrangement, (i.e., the first tooth arrangement is a tooth arrangement of the patient after the first treatment step from the initial tooth arrangement); the shape of the second dental appliance corresponds to the second tooth arrangement, (i.e., the second tooth arrangement is a tooth arrangement of the patient after the second treatment step from the first tooth arrangement); . . . the shape of the last dental appliance corresponds to the expected tooth arrangement, (i.e., the expected tooth arrangement is the tooth arrangement at the end of the last treatment step). Therefore, in order to manufacture a series of dental appliances, a series of tooth arrangements corresponding to the series of dental appliances should be determined, i.e., the tooth arrangement (such as the tooth position) after each orthodontic treatment step should be determined.

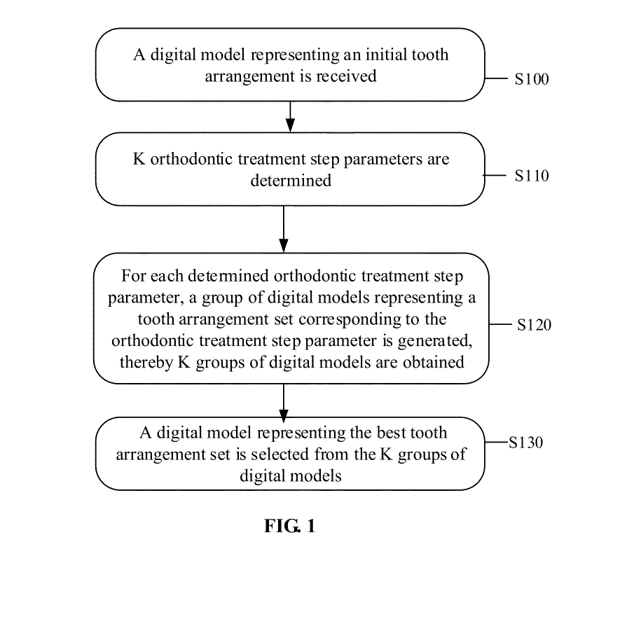

Accordingly, a method for generating tooth arrangements is first provided by the present disclosure. The method calculates a series of tooth arrangements by predefining the number of treatment steps. The present disclosure will be exemplarily illustrated below by referring to FIG. 1.

FIG. 1 illustrates a flowchart of a method for generating tooth arrangements according to an embodiment of the present disclosure. In the method illustrated in FIG. 1, at first in step S100, a digital model representing an initial tooth arrangement is received. For example, the digital model representing the initial tooth arrangement of a patient is received. The patient's initial tooth arrangement includes the patient's tooth arrangement, and/or arrangement of tissues surrounding the teeth, such as the alveolus mucous membrane and the facial soft tissue. Furthermore, the initial tooth arrangement represents the patient's original tooth arrangement before the orthodontic treatment.

The digital model representing the initial tooth arrangement may be generated by a variety of methods. For example, a physical dental model may be generated from a tooth arrangement determined by utilizing a impression-taking process. Methods such as optical scanning, X-ray imaging, ultrasound imaging, 3D photographing, 3D imaging, medical CT scanning or magnetic resonance imaging (MRI) may be used to directly obtain the image of teeth, or the image of teeth and their surrounding tissues. Further, the captured tooth arrangement, or the status of teeth and their surrounding tissues may be converted into a data set of the tooth arrangement by scanning the physical dental model, or by processing the image of the oral tissues with a computer, thereby obtaining the X, Y, Z coordinates of the teeth in a three dimensional space which may be visualized and manipulated (such as translation or rotation) via a graphical interface of a computer system. The digital model representing the initial tooth arrangement may represent an upper jaw dentition and/or a low jaw dentition of the initial tooth arrangement.

Generally, the patient's plaster dentition model may be obtained by the impression-taking process according to common technology in the art, and then a data set representing the tooth arrangement is generated by scanning the patient's plaster dentition model using a scanner, for example, a non-contacting laser scanner or a contacting laser scanner, etc. Moreover, the data set generated by the scanner may be presented in any one of a variety of digital formats to ensure software compatibility.

Since the digital model representing the initial tooth arrangement may be an upper jaw dentition and/or a low jaw dentition of the initial tooth arrangement, if the digital model representing the initial tooth arrangement includes the upper jaw dentition and the low jaw dentition, then the patient's paraffin bite mark may be used to obtain a position of the upper jaw dentition relative to the low jaw dentition in a centric occlusion position. For example, when a laser scanner is used, the paraffin bite mark may be put on the patient's plaster model of the lower jaw dentition, then the upper jaw dentition may be put on the lower jaw dentition such that the position of the upper dentition relative to the lower jaw dentition is determined. After that, an upper jaw dentition model and a lower jaw dentition model representing the same relative position as that within the patient's mouth may be obtained. Alternatively, the digital models of the upper and lower jaw dentitions representing the patient's initial tooth arrangement may also be obtained by scanning the paraffin bite mark only and combining the scanned data of the paraffin bite mark with the scanned data of the plaster model.

Further, as described above, the patient's initial tooth arrangement in the present disclosure may include not only the arrangement of the patient's teeth, but also the status of surrounding tissues (such as the alveolus mucous membrane and the facial soft tissue). Moreover, the tooth arrangement may include not only the crown arrangement, but also the root arrangement. For example, the digital models of the roots and their surrounding tissues may be obtained by a two dimensional or three dimensional X-ray system, CT scanner or MRI.

Moreover, in this step, a digital model of each tooth may be further obtained based on the obtained digital model of the dentition. That is, the above digital model of the upper jaw dentition and the lower jaw dentition obtained by scanning may be separated into a plurality of single-tooth digital models by automatic separation with a computer, manual separation or a combination of automatic separation and manual separation, and then coordinates of each tooth may be determined.

In step S100, as described above, according to an embodiment, the digital model of the entire upper jaw dentition and/or the entire lower jaw dentition may be first obtained and then the digital model can be separated into the plurality of single-tooth digital models. According to another embodiment, the plaster model of the dentition obtained by the impression-taking process may be separated first to obtain a plurality of single-tooth plaster models, and the position of each tooth in the dentition or the relative position between different teeth are recorded. Then each tooth is scanned to obtain a digital model thereof. Then the entire dentition, i.e., the digital model representing the patient's initial tooth arrangement, is obtained using a computer based on the recorded position of each tooth in the dentition or their relative positions. The aforementioned embodiments are exemplary and not limiting, and all methods that can be used to obtain the digital model of the patient's initial tooth arrangement fall into the scope of the present disclosure.

In another aspect, in step S110, the orthodontic treatment step parameter is determined. The main problem encountered in designing and manufacturing dental appliances is how to move from the patient's initial tooth arrangement to the target tooth arrangement through a series of orthodontic treatment tooth arrangements. The minimum number of movement steps and the optimal target position (i.e., the optimal target tooth arrangement) are two mutually exclusive variables. More movement steps can bring better target position. Thus, it is difficult to optimize both the number of movement steps and the target position in a single optimization process. An intuitive method in the art is fixing the target position first and then optimizing the number of movement steps, or only considering a feasible moving scheme that can achieve the target position during the optimization process, which can not ensure the optimal number of movement steps.

For example, for the method of first fixing the target tooth position and then optimizing the moving steps, the target tooth position is determined at first based on the initial position (the target position may be determined manually, or semi-automatically or fully automatically by setting a medical rule and an algorithm), then a series of intermediate tooth movement positions are calculated automatically based on the initial position and the target position. These intermediate positions are generated by linear or non-linear interpolations based on the difference between the target position and the initial position. Teeth collisions should be taken into account during the process of interpolating the intermediate positions. When all of the interpolated intermediate positions cannot form a path that moves the teeth freely, a random search method is used to add new intermediate positions such that the added new intermediate positions and the interpolated positions form a feasible moving path from the initial position to the target position. Moreover, this method also permits setting target intermediate positions between the initial position and the target position, and the intermediate positions between these target intermediate positions are also generated by linear or non-linear interpolation. Although it is intuitive to set the target position manually and then generate the intermediate positions based on the initial position, such method separates the target position and the intermediate positions and thus cannot achieve an overall optimality of the both. When the target position is given, several intermediate positions, for example, 30 steps, may be needed in a feasible optimal path. However, it may also be possible that there is a sub-optimal target position which is slightly different from the given target position. Such difference is clinically acceptable, and less steps such as 15 steps may be required to achieve the sub-optimal position. Therefore, such method may require too many treatment steps but have little effect on the target position. Moreover, when the target position is determined, the interpolation method is used to calculate the intermediate positions for this method. However, the interpolation method cannot ensure that the resultant path is optimal and it is possible that less intermediate positions are required to achieve the target position. Furthermore, the predetermined target position may not be medically achievable or reasonably achievable, and thus it may be impossible or difficult to implement the method in clinic.

The present disclosure provides a method for predetermining the orthodontic treatment step parameter. The orthodontic treatment step parameter represents the number of orthodontic treatment steps for moving an initial tooth arrangement to a target tooth arrangement. All possible tooth arrangement sets are obtained by calculating a corresponding tooth arrangement for each possible orthodontic treatment step (or movement step), and then a tooth arrangement set that has the best clinical effect or best meet patient's requirement is selected as the best tooth arrangement set from all the possible tooth arrangements sets, which can be used for the sequent dental appliance manufacturing.

Therefore, in step S110, all possible orthodontic treatment step parameters, i.e., K orthodontic treatment step parameters, are determined. Each orthodontic treatment step parameter represents a number of orthodontic treatment steps for moving the initial tooth arrangement to the expected tooth arrangement.

According to the present disclosure, the number of the orthodontic treatment step parameters is K and K may be any integer greater than or equal to 1. In consideration of actual practice, a treatment course generally includes 25-50 orthodontic treatment steps, therefore K is optionally chosen to be an integer greater than or equal to 1 and less than or equal to 50. Moreover, each orthodontic treatment step parameter represents the number of orthodontic treatment step for moving the initial tooth arrangement to the target tooth arrangement, and thus it is also optionally chosen to be an integer greater than or equal to 1 and less than or equal to 50.

For example, in an embodiment, if the treatment course includes at most 50 orthodontic treatment steps, then 50 orthodontic treatment steps are determined and are respectively denoted by S₁, S₂, S₃, S₄, S₅, S₆, S₇, . . . , S₅₀ i.e., the value of K is 50. The value of orthodontic treatment step parameter S₁ is equal to 1, which indicates that the number of orthodontic treatment steps for moving the initial tooth arrangement to the target tooth arrangement is 1. The value of orthodontic treatment step parameter S₂ is equal to 2, which indicates that the number of orthodontic treatment steps for moving the initial tooth arrangement to the target tooth arrangement is 2. The value of orthodontic treatment step parameter S₃ is equal to 3, which indicates that the number of orthodontic treatment steps for moving the initial tooth arrangement to the target tooth arrangement is 3. The value of orthodontic treatment step parameter S₅₀ is equal to 50, which indicates that the number of orthodontic treatment steps for moving the initial tooth arrangement to the target tooth arrangement is 50.

In another embodiment, if the treatment course includes at most 50 orthodontic treatment steps, it may calculate only 10 orthodontic treatment step parameters, which are denoted respectively by S₁, S₂, S₃, S₄, S₅, S₆, S₇, . . . , S₁₀. Further, the value of orthodontic treatment step parameter S₁ is equal to 5, which indicates that the number of orthodontic treatment steps for moving the initial tooth arrangement to the target tooth arrangement is 5. The value of orthodontic treatment step parameter S₂ is equal to 10, which indicates that the number of orthodontic treatment steps for moving the initial tooth arrangement to the target tooth arrangement is 10. The value of orthodontic treatment step parameter S₃ is equal to 15, which indicates that the number of orthodontic treatment steps for moving the initial tooth arrangement to the target tooth arrangement is 15. The value of orthodontic treatment step parameter S₁₀ is equal to 50, which indicates that the number of orthodontic treatment steps for moving the initial tooth arrangement to the target tooth arrangement is 50. That is, in this embodiment, not all of the possible movement steps are selected for calculation, and instead, only a portion of movement steps are selected at intervals for calculation, thereby reducing the calculation.

Moreover, it is not required to select the number of movement steps at a fixed interval. For example, in an embodiment, if there are at most 50 orthodontic treatment steps in a treatment course, only 10 orthodontic treatment steps are determined to be calculated, which are denoted by S₁, S₂, S₃, S₄, S₅, S₆, S₇, . . . , S₁₀. Further, the value of orthodontic treatment step parameter S₁ is equal to 5, which indicates that the number of the orthodontic treatment steps for moving the initial tooth arrangement to the target tooth arrangement is 5. The value of orthodontic treatment step parameter S₂ is equal to 11, which indicates that the number of the orthodontic treatment steps for moving the initial tooth arrangement to the target tooth arrangement is 11. The value of orthodontic treatment step parameter S₃ is equal to 14, which indicates that the number of the orthodontic treatment steps for moving the initial tooth arrangement to the target tooth arrangement is 14. The value of orthodontic treatment step parameter S₁₀ is equal to 50, which indicates that the number of the orthodontic treatment steps for moving the initial tooth arrangement to the target tooth arrangement is 50.

Therefore, the number of the orthodontic treatment step parameters and the value of the orthodontic treatment step parameter may be flexibly determined based on actual requirements.

It should be noted that, the present disclosure does not limit the order of step S100 in which the digital model representing the initial tooth arrangement is received and step S110 in which the K orthodontic treatment step parameters are determined. That is, step S100 may be executed before or after step S110, or steps S110 and S110 may be executed simultaneously. The present disclosure does not limit the order of these steps.

Further, as shown in FIG. 1, in step S120, for each determined orthodontic treatment step parameter, a group of digital models representing a tooth arrangement set, which correspond to the orthodontic treatment step parameter, are generated, thereby K groups of digital models are obtained.

Step S120 will be described below in more details by taking K=10 as an example. The 10 orthodontic treatment step parameters are respectively denoted by S₁, S₂, S₃, S₄, S₅, S₆, S₇, . . . and S₁₀. Further, the value of orthodontic treatment step parameter S₁ is equal to 5, which indicates that the number of the orthodontic treatment steps for moving the initial tooth arrangement to the target tooth arrangement is 5. The value of orthodontic treatment step parameter S₂ is equal to 10, which indicates that the number of the orthodontic treatment steps for moving the initial tooth arrangement to the target tooth arrangement is 10. The value of orthodontic treatment step parameter S₃ is equal to 15, which indicates that the number of the orthodontic treatment steps for moving the initial tooth arrangement to the target tooth arrangement is 15 . . . . The value of orthodontic treatment step parameter S₁₀ is equal to 50, which indicates that the number of orthodontic treatment steps for moving the initial tooth arrangement to the target tooth arrangement is 50. For each orthodontic treatment step parameter, a group of digital models representing a tooth arrangement set, which correspond to the orthodontic treatment step parameter, will be generated. Each tooth arrangement set that corresponds to an orthodontic treatment step parameter includes a target tooth arrangement and a plurality of intermediate tooth arrangements progressively changing into the target tooth arrangement, and the number of the plurality of intermediate tooth arrangements included in each tooth arrangement set is determined by the corresponding orthodontic treatment step parameter. For example, as to orthodontic treatment step parameter S₁ (S₁=5), the tooth arrangement set corresponding to S₁ includes a target tooth arrangement and 4 intermediate tooth arrangements progressively changing from the initial tooth arrangement into the target tooth arrangement. As to the orthodontic treatment step parameter S₁₀ (S₁₀=50), the tooth arrangement set corresponding to S₁₀ includes a target tooth arrangement and 49 intermediate tooth arrangements progressively changing from the initial tooth arrangement into the target tooth arrangement.

In step S120, a group of digital models representing a tooth arrangement set corresponding to the orthodontic treatment step parameter are generated for each determined orthodontic treatment step parameter (e.g. S₁, S₂, S₃, S₄, S₅, S₆, S₇ . . . S₁₀, thereby K groups (for example, 10 groups) of digital models are obtained.

First, for orthodontic treatment step parameter S₁, the number of orthodontic treatment steps needed for moving the initial tooth arrangement to the target tooth arrangement is five, a movement path that moves through 5 steps from the initial tooth arrangement to the achievable optimal target tooth arrangement is determined. That is, for orthodontic treatment step parameter S₁, it is required to determine four intermediate tooth arrangements and a target tooth arrangement in conformity with medical rules.

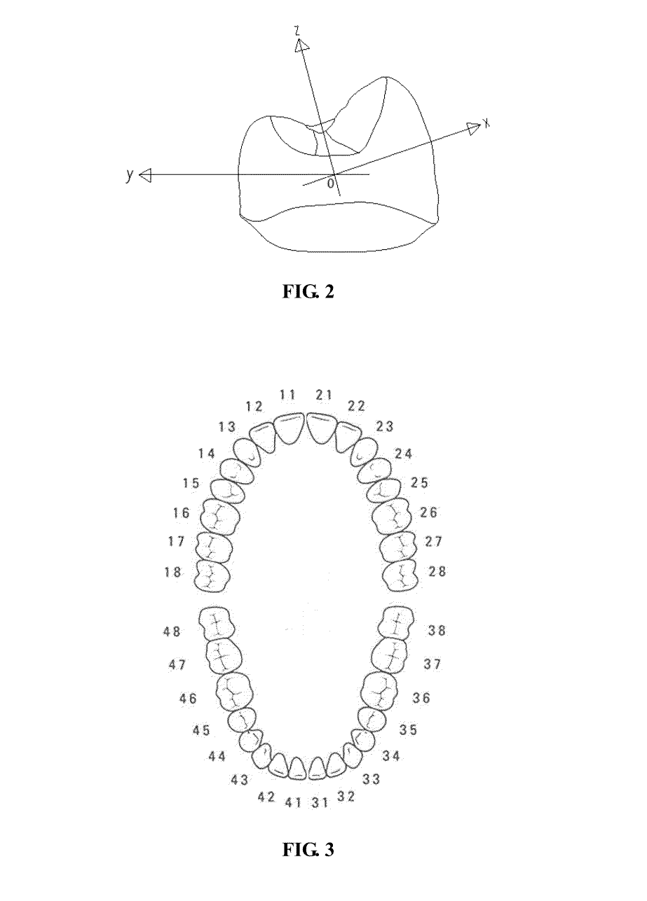

Mathematically, how to optimize an object position based on the medical rules is a multi-objective optimization problem. Assuming that the number of teeth is N, as shown in FIG. 2, in a three dimensional Cartesian coordinate system, the direction and amount of translation of each tooth may be denoted by the following: amount of translation along the X axis, amount of translation along the Y axis, amount of translation along the Z axis, a rotation angle about the X axis, a rotation angle about the Y axis, and a rotation angle about the Z axis. That is, the movement of each tooth may be specifically defined by the above 6 translation and rotation variables (Tx, Ty, Tz, Rx, Ry, Rz).

Tx denotes the amount of translation along the X axis, Ty denotes the amount of translation along the Y axis, Tz denotes the amount of translation along the Z axis, Rx denotes the rotation angle about the X axis, Ry denotes the rotation angle about the Y axis, and Rz denotes the rotation angle about the Z axis.

Assuming that the total number of teeth of the entire dentition is N, then a movement vector of a tooth with index j is denoted by (Txⱼ, Tyⱼ, Tzⱼ, Rxⱼ, Ryⱼ, Rzⱼ). For example, as shown in the teeth positions in FIG. 3, the upper jaw dentition includes 16 teeth in total, and the lower jaw dentition includes 16 teeth in total. Therefore, if only the movement of the upper jaw dentition is considered, the movement vectors of the 16 teeth are required to be considered in total.

Therefore, the movement vector of the tooth with index j at an i-th step may be denoted by (Tx_{i,j}, Ty_{i,j}, Ry_{i,j}, Rz_{i,j}). Thus, for N teeth and the given orthodontic treatment step parameter Sₖ, the movements of all the teeth in Sₖ steps are denoted by X, where X includes 6*N*Sₖ variables. For example, in this example, N=16, Sₖ=S₁=5, then the movement variable set X includes 480 variables in total.

Therefore, a multi-objective optimization model is created to determine x (x is the solution of the movement variable set X) such that the determined x satisfies all inequality constraints g(x)>=0, l(x)=0 for all equality constraints, and an objective function F(x)={f1(x),f2(x), . . . , fn(x)} has a minimum value or a maximum value. Since conflicts always occur between multiple objective functions, it is rare that a single solution makes all of the objections function minimum or maximum. Therefore, a groups of Pareto optimal solutions are used to denote a solution set of a multiple objective function. In a set including all the solutions, a suitable solution may be manually chosen as the final solution. A computer may also be used to automatically make the decision to choose the best solution.

In order to create the multiple objective optimization model, an objective function f(x), an equality constraint g (x) and an inequality constraint l(x) are needed to be determined. In particular, in the present disclosure, the objective function f(x), the equality constraint g (x) and the inequality constraint l(x) are created based on one or more rules required by appearance and clinic requirements (collectively called as medical parameters) and constraints determined by orthodontic treatment techniques (collectively called as orthodontic treatment constraints). Details will be elaborated in the following paragraphs.

First, the medical parameters include: curve of dental arch, degree of dental crowding, amount of interproximal reduction, overjet, overbite, dental arch convexity, depth of curve of Spee, Bolton ratio, dental arch width, arch symmetry, degree of tooth torsion, angulation of crown, tongue, midline and profile of facial soft issue. Please refer to the summary section of the present disclosure for the definitions of the aforementioned medical parameters. The dental arch will be taken as an example for description in the following. It should be noted that, the aforementioned medical parameters are exemplary only and are not limiting. All other orthodontic treatment constraints commonly used in the art fall in the scope of the present disclosure.

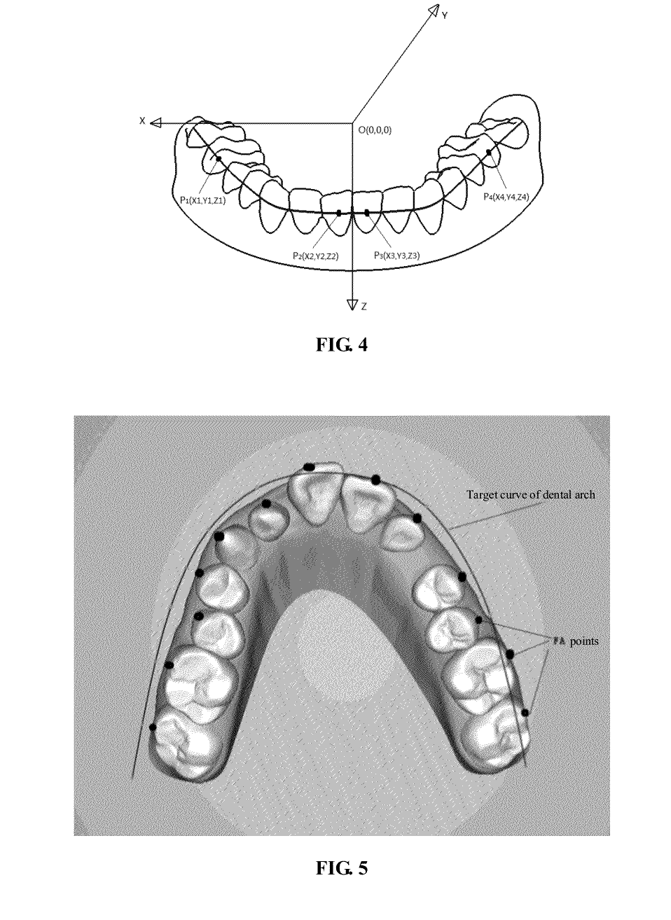

Teeth sit on the gum in an arch shape along the alveolar bone. The curve that connects the dental arch of all teeth of the upper jaw is the curve of maxillary dental arch, and the curve that connects the dental arch of all teeth of the lower jaw is the curve of mandible dental arch. A variety of methods may be employed to generate the curves of dental arch. FIG. 4 illustrates a front view of a dental model. A global three dimensional Cartesian coordinate system is shown in FIG. 4, where an origin O may be chosen at a geometrical center of the dental model of the lower jaw. FA points of the left and right first molars, the left and right middle incisors may be selected respectively as four base points P₀, P₁, P₂ and P₃ of the initial curve of dental arch. Coordinates of the four base points may be respectively denoted by P₀(X0, Y0, Z0), P₁(X1, Y1, Z1), P₂(X2, Y2, Z2) and P₃(X3, Y3, Z3) in the Cartesian coordinate system, where X0˜3, Y0˜3, Z0˜3 are values of the basic points X, Y, Z in the space axes. The “FA point” refers to the central point of the FACC curve that extends from the occlusal edge to the gingival edge on the surface of the clinic crown. For the incisor, the cuspid and the front molar, FACC is the central curve of the labial cheek surface of the clinic crown. For the molar, FACC extends along the cheek groove and its two ends are respectively called as “occlusal point” and “gingival point”.

Based on the above four base points P₀, P₁, P₂ and P₃, the curve of dental arch may be generated by the following equation (1):

$${P}_{0 , 3} ( t ) = \frac{1}{6} [ 1 t {t}^{2} {t}^{3} ] [ \begin{matrix}- α & β & - β & α \\ β & γ & β & 0 \\ - β & 0 & β & 0 \\ α & ξ & α & 0\end{matrix} ] [ \begin{matrix}{P}_{0} \\ {P}_{1} \\ {P}_{2} \\ {P}_{3}\end{matrix} ] , t ∈ [ 0 , 1 ] \qquad equation ( 1 )$$

where α, β, γ and ξ are appropriately selected constant values, for example, these values may be selected as α=1, β=3, γ=6, ξ=4. It will be appreciated that other constant value may also be selected.

The X, Y, Z components of the four base points P₀, P₁, P₂ and P₃ in the three dimensional Cartesian coordinate system may be denoted respectively as:

$$\begin{matrix}X ( t ) = \frac{1}{6} [ {t}^{3} {t}^{2} t 1 ] [ \begin{matrix}- α & β & - β & α \\ β & γ & β & 0 \\ - β & 0 & β & 0 \\ α & ξ & α & 0\end{matrix} ] [ \begin{matrix}{X}_{0} \\ {X}_{1} \\ {X}_{2} \\ {X}_{3}\end{matrix} ] , t ∈ [ 0 , 1 ] & equation ( 2 ) \\ Y ( t ) = \frac{1}{6} [ {t}^{3} {t}^{2} t 1 ] [ \begin{matrix}- α & β & - β & α \\ β & γ & β & 0 \\ - β & 0 & β & 0 \\ α & ξ & α & 0\end{matrix} ] [ \begin{matrix}{Y}_{0} \\ {Y}_{1} \\ {Y}_{2} \\ {Y}_{3}\end{matrix} ] , t ∈ [ 0 , 1 ] & equation ( 3 ) \\ Z ( t ) = \frac{1}{6} [ {t}^{3} {t}^{2} t 1 ] [ \begin{matrix}- α & β & - β & α \\ β & γ & β & 0 \\ - β & 0 & β & 0 \\ α & ξ & α & 0\end{matrix} ] [ \begin{matrix}{Z}_{0} \\ {Z}_{1} \\ {Z}_{2} \\ {Z}_{3}\end{matrix} ] , t ∈ [ 0 , 1 ] & equation ( 4 )\end{matrix}$$

Although a specific method for calculating the curve of dental arch is described above, it may be understood for an artisan in the art that various methods may be used for calculating the curve of dental arch and not limited to the aforementioned embodiments. For example, the FA points of the left and right first molars, the left and right cuspids, and the left and right middle incisors may also be selected as the 6 base points to fit the curve of dental arch.

Alternatively, three adjacent points in the posterior teeth area and the incisor teeth area may be selected, based on which a curve of dental arch can be fitted. The “adjacent points” refer to the most protruding point of dissection contour of dental crown along the mesio-distal direction in the dental coordinates. As another alternative embodiment, normal biting contact points of the teeth that arrange generally normally within the dental arch may be selected to fit the curve of dental arch. Here, stable contact between dentitions of the upper jaw and the low jaw may be achieved in two ways. The first way is to make the tooth cusp and the tooth fossa face to each other. Another way is to make the tooth cusp and the marginal ridge face to each other. Both of these two ways can achieve stable stop contact. In addition, a reference curve of the lingual side may also be selected. In this case, the central points of the first molars, the second molars, the cuspids and middle incisors on both sides of the dental arch may be selected respectively to fit a “mushroom-shaped” curve of dental arch of the lingual side.

Further, based on the curve of dental arch in FIG. 4 (i.e., the curve of dental arch generated based on the patient's initial tooth arrangement), a target curve of dental arch is formed after several adjustments. Here, a user (for example, an operator) may manually slightly tune the initial curve of dental arch shown on a computer graphical interface based on requirements of the clinic treatment. The target curve of dental arch is formed by adjusting the shape and length of the dental arch (for example, lip extension, arch spread, and molar distalization). A suitable standard target curve of dental arch may also be selected as the target curve of dental arch from a set of standard target curves of dental arches formed based on a case database by a computer. Both the tuning operation and the target curve of dental arch may be dynamically shown via the computer graphical interface such that the operator may observe whether the target curve of dental arch meets the requirements of the clinical treatment. In an embodiment, if a clinician determines, based on actual clinic condition, that a patient's front tooth protrudes outward and needs to be moved inward, he may tune the initial curve of dental arch shown in FIG. 4 to make the front teeth segment of the initial curve of dental arch move inward to form the target curve of dental arch.

Next, a rule that the resultant tooth arrangement must align with the target curve of dental arch is defined. For example, the FA points of all the teeth in the resultant tooth arrangement are on the target curve of dental arch. It may also define that the cusp points of all the teeth are on the target curve of dental arch. The present disclosure makes no limitation on the definition of the rule. When the tooth alignment process is implemented automatically by a computer, the description of the medical rule needs to be converted into a quantized mathematical objective function. Therefore, if the shortest distance from the FA point (the black marked point on the tooth in FIG. 5) of the i-th tooth to the target curve of dental arch is Di, then the objective function for alignment with the target curve of dental arch (the curve in FIG. 5) may be denoted by f(x)=D1+D2+ . . . +Dn. The value of x is selected to minimize the value of f(x), then optimization of “alignment with the target curve of dental arch” is achieved.

The above is an example of creating the objective function with reference to the curve of dental arch. Methods of creating the objective functions based on other medical parameters are similar and thus will not elaborated herein. In general, all the rules used in clinic for defining the target positions may be used in the process of solving the methods described in the present disclosure by function expression.

Furthermore, the medical rules defining the orthodontic treatment constraints refer to various constraints on the tooth movement during the process of orthodontic treatment. When the orthodontic treatment constraints are described by an optimization method, they can be classified into two catalogs, one is inequality constraint, and the other is equality constraint. The definition of the orthodontic treatment constraint may refer to the summary section. However, it should be noted that, the orthodontic treatment constraints enumerated above are exemplary only and all the other orthodontic treatment constraints commonly used in the art fall into the scope of the present disclosure.

An example of the inequality constraint is that no collision is allowed between two teeth. This constraint may be defined as that the minimum distance between any two teeth is greater than zero, i.e., if the distance between tooth m and tooth n is defined as d(m, n), then d(m, n)>=0.

An example of the equality constraint is that the sum of forces applied during a single step movement is equal to 0. If a force required for the movement of tooth m is Fm, which is a vector with amount and direction, then the sum of the forces required for all the teeth is f=F1+F2+ . . . +Fn, and it is required that f=0.

The method for creating the orthodontic treatment constraints is described above with reference to considering only the collision avoidance between teeth and the sum of forces being equal to 0 in each orthodontic treatment step. The methods for creating the objective functions based on other orthodontic treatment constraints are similar and will not elaborated herein.

According to the embodiments of the present disclosure, each of the above medical parameters and the orthodontic treatment constraints may be defined by an operator via the computer graphical interface, and then the defined medical parameters and orthodontic treatment constraint parameters may be combined and applied to the dental model.

After creating the multiple objective functions and the constraints, the multi-objective optimization problem is to be solved. The multi-objective optimization problem is mathematically solvable. One of the methods may first convert the multi-objective optimization problem into a single-objective optimization problem by a weighted combination of the multiple objects. Another method may solve the multi-objective optimization problem directly. Global optimization algorithms such as gene algorithm or simulated annealing algorithm may be used to solve the single-objective or multi-objective optimization problem.

According to another embodiment, the simulated annealing algorithm may be used to solve the single-objective or multi-objective optimization problem. The simulated annealing algorithm is widely used to solve the single-objective or multi-objective optimization problems. The idea of the algorithm originates from the principle of solid annealing. According to the principle of solid annealing, a solid is heated to a high temperature and then cooled down slowly. When the solid is heated, internal particles within the solid becomes orderless with elevated temperature, and the internal energy of the internal particles increases accordingly. When the temperature cools down slowly, the particles becomes progressively in order and achieve an equilibrant state at each temperature, and finally achieve a base state at the room temperature and the internal energy decreases to a minimum value. According to the Metropolis Criterion, the probability of the particles approaching the equilibrant state at a temperature T is equal to e^{(-ΔE/(kT))}, where E denotes the internal energy at the temperature T, ΔE denotes variation of the internal energy, k denotes the Boltzmann constant. When the solid annealing algorithm is used to simulate the problem of combination optimization, by simulating internal energy E with the objective function f and the temperature T with control parameter t, the simulated annealing algorithm for solving the combination optimization problem can be obtained: starting from an initial solution i and an initial value of the control parameter t, repeating iterations of “generating a new solution→calculating a difference of the objective function→accepting or discarding”, and gradually reducing the value of t. Then the current solution at the termination of the algorithm is an approximate optimization solution. The above process is a heuristic random search process based on the Monte Carlo iteration algorithm. The annealing process is controlled by a cooling schedule table which includes an initial value of the control parameter t and its attenuation factor Δt, an iteration number L for each value oft and a stop condition S.

The simulated annealing algorithm is first applied in the field of combination optimization by Kirkpatrick et al. It is a random optimization algorithm based on the Monte-Carlo iterative solving strategy. The simulated annealing algorithm uses a temperature parameter starting from a relatively high initial temperature and decreases gradually, in combination with probabilistic jumping property, and then a global optimization solution to the objective function is randomly searched in a solution space. That is, it can probabilistically jump out at a locally optimal solution and finally approach a global optimal solution. The simulated annealing algorithm is a universal algorithm which theoretically has a probabilistically global optimal performance and has been widely used in engineering fields such as VLSI, manufacture scheduling, control engineering, machine learning, neural network, signal processing. The simulated annealing algorithm is a serially-structured optimization algorithm which effectively avoids being trapped into a local minima and finally approaches a globally optimal solution by granting the searching process a time-variant probabilistic jumping property that finally approaches zero. Models and basic ideas relating to the simulated annealing algorithm may be referred to the article “A survey of Simulated Annealing as a Tool for Single and Multiobjective Optimization, B Suman, P Kumar, Journal of the Operation Research Society (2006) 57, 1143-1160”.

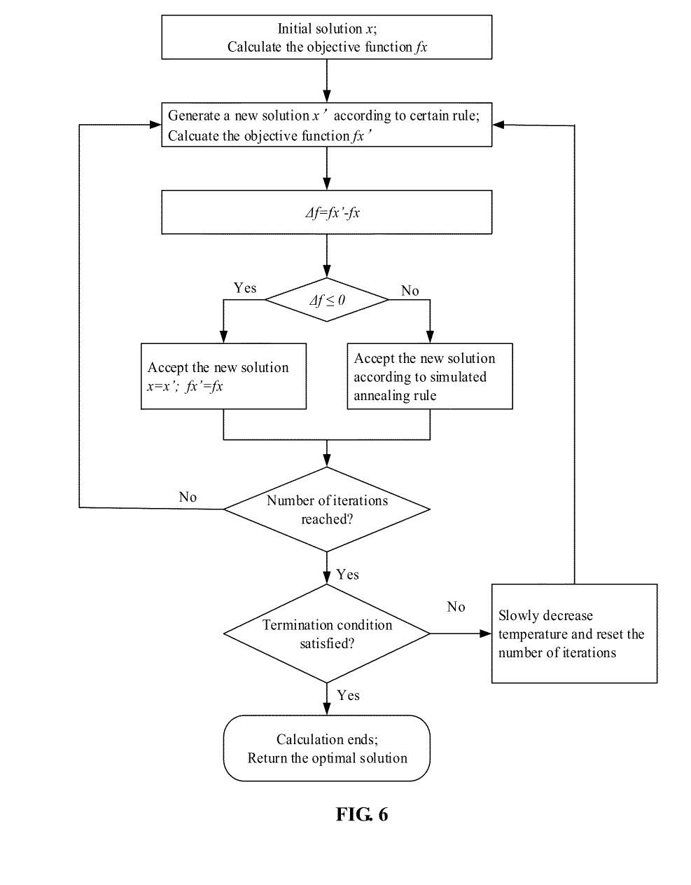

According to an embodiment of the present disclosure and according to the exemplary flowchart of the simulated annealing algorithm illustrated in FIG. 6, during the optimization process, it is required to provide an initial solution x₀, and better solutions can be found by iteration until an optimal solution is found. Assuming that the value of the objective function at the k-th iteration is fₖ, then for current solution xk, a new solution xₖ₊₁=xₖ+delta is generated by making a small change (i.e., a small number randomly generated according to certain rules) to xₖ. After that, it is first determined whether the new solution xₖ₊₁ satisfies all the equality constraints and inequality constraints. If it dissatisfies, then a new solution is generated; and if it satisfies, then the value of the objection function fₖ₊₁ is calculated. Then it is determined whether or not to accept the new solution according to the simulated annealing requirement. If the new solution satisfies the requirement, then the new solution xₖ₊₁ is accepted; otherwise, a new solution is generated. The value of the objective function corresponding to the new solution is then compared with that of the current solution. The process continues until a better solution is found or the optimization process has converged. The solution generated at the termination of the iteration process is outputted as the final solution.

In view of the foregoing, a group of digital models of a tooth arrangement set corresponding to an orthodontic treatment step parameter such as S1 may be calculated by a global optimization algorithm (for example, the simulated annealing algorithm) based on a multi-objective optimization model defined by various medical parameters and orthodontic treatment constraints. Then, the above steps may be repeated such that in step S120, a group of digital models of a tooth arrangement set corresponding to each of the K orthodontic treatment step parameters is calculated and thus the K groups of digital models are obtained.

Next, in step S130, digital models representing the best tooth arrangement set are selected from the K groups of digital models. In an exemplary embodiment, after the K groups of digital models are obtained, the optimal solution of the objective function calculated by the global optimization algorithm for each of the K orthodontic treatment step parameters is determined as the value of the objective function corresponding to the orthodontic treatment step parameter. The predefined rule may be at least one of the aforementioned medical parameters or orthodontic treatment constraints. For example, if the “alignment with the target curve of dental arch” is the predefined rule, then the objective function of the curve of dental arch described may be used. If it is defined that the shortest distance from the FA point of the i-th tooth of the target tooth arrangements included in each tooth arrangement set to the best curve of dental arch is Di, then the objective function for the “alignment with the target curve of dental arch” rule is denoted by f(x)=D1+D2+ . . . +Dn. For the K groups of digital models, x=S₁, S₂, S₃, S₄, S₅, S₆, S₇, . . . , S_{K}, and then the values of f(S₁), f(S₂), f(S₃), f(S₄), f(S₅), f(S₆), f(S₇), . . . , f(S_{K}) may be calculated.

Next, a graph that represents the correspondence between the calculated value of the objective function and the orthodontic treatment step parameter may be generated. The graph may be a curve graph, a line chart, a histogram, a bar diagram, etc. The present disclosure does not limit the types of the graph. Moreover, the graph may be shown to the user via the computer graphical interface or in other ways such that the user may select the best tooth arrangement set based on the graph.

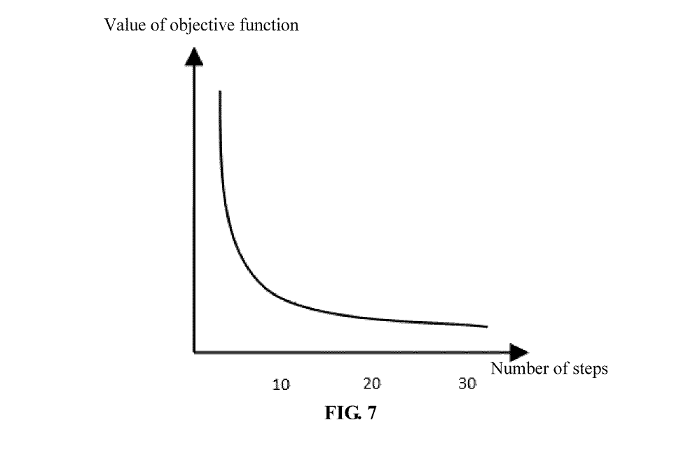

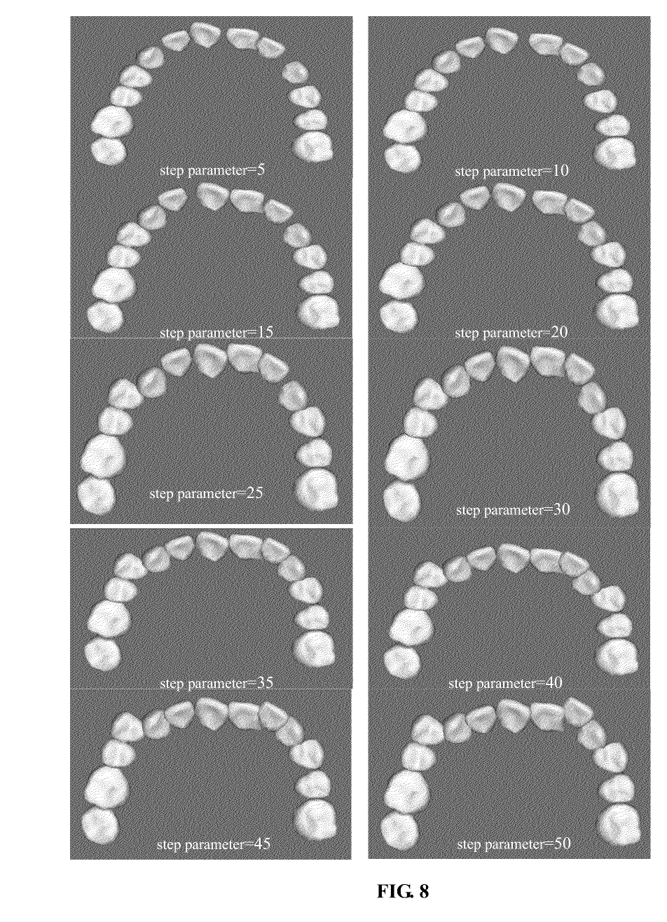

In an exemplary embodiment, a curve graph that represents the correspondence between the calculated value of the objective function and the orthodontic treatment step parameter is generated. For example, FIG. 7 is a curve graph with the orthodontic treatment step parameter (the number of steps) as its horizontal coordinate and the calculated value of the objective function f(x) of the curve of dental arch as its vertical coordinate. It can be seen from the graph that the objective function of the curve of dental arch is positively dependent on the value of the orthodontic treatment step. That is, the smaller the difference between the target tooth arrangement and the expected curve of dental arch is, the better the effect of the tooth alignment process is. However, when the orthodontic treatment step parameter exceeds a certain value, i.e., the number of steps exceeds a certain value, the improvement to the target position due to the increase of number of steps may be minor. Thus, the user (the user here may be a computer operator, a physician, a technician or a patient) may balance between the number of steps and the target position to select the optimal number of movement steps and the corresponding achievable target tooth arrangement, thereby determining the best tooth arrangement set.

This method also provides a method for selecting the optimal number of steps, which can be automatically executed by a computer. For example, an inflection point of the objective function with respect to the orthodontic treatment step parameter may be calculated by the computer, and the tooth arrangement set corresponding to the inflection point may be determined as the best tooth arrangement set.

Moreover, according to another embodiment, the best tooth arrangement set may also be determined directly by the user based on the tooth arrangement image. In particular, after the K groups of digital models are obtained, the target tooth arrangement image of each tooth arrangement set is shown to the user by a computer graphical interface or in other ways well known to an artisan in the art. FIG. 8 illustrates images of target tooth arrangements corresponding to different orthodontic treatment step parameters according to an embodiment of the present disclosure. As shown in FIG. 8, after 10 groups of digital models (orthodontic treatment step parameters are respectively equal to 5, 10, 15, 20, 25, 30, 35, 40, 45, and 50) are obtained, the target tooth arrangement image included in each tooth arrangement set is shown to the user by a computer graphical interface or in other ways commonly known by an artisan in the art.

Afterwards, a tooth arrangement that has the optimal target tooth arrangement is selected by the user as the best tooth arrangement set. The optimal target tooth arrangement refers to a target tooth arrangement that there is a best tradeoff between the number of movement steps and the target tooth arrangement (e.g., the inflection point of the objective function). For example, gaps between teeth of the initial tooth arrangement (not shown) shown in FIG. 8 are large, thus a main objective of the orthodontic treatment is to reduce the gaps between teeth. It can be seen from the figures of the target tooth arrangement after the tooth alignment process, when the orthodontic treatment step parameter is equal to 35, the gaps between teeth of the objective tooth arrangement has almost been removed, therefore it can be determined that the inflection point has been achieved when the orthodontic treatment step parameter is equal to 35.

Moreover, the user may select a tooth arrangement set that is optimal based on a balanced consideration of the target tooth arrangement and orthodontic treatment step parameter as the best tooth arrangement set. The optimal tooth arrangement based on a balanced consideration refers to the optimal tooth arrangement determined according to the user's actual requirement. For example, even if the result of the tooth alignment process shows an inflection point is achieved “when the number of orthodontic treatment steps is equal to 35”, but if the user thinks that the cost of 35 steps is high and also accepts the tooth arrangement obtained by an orthodontic treatment scheme consisting of 30 steps, then the user may select the orthodontic treatment scheme consisting of 30 steps, thereby the user can balance between the effect of the treatment and the time/cost of the treatment according to the actual requirement thereof.

Further, according to another embodiment of the present disclosure, after the K groups of digital models are obtained, the intermediate tooth arrangements and the target tooth arrangement included in each tooth arrangement set may also be shown to the user. For example, when 10 groups of digital models (the orthodontic treatment step parameters are respectively equal to 5, 10, 15, 20, 25, 30, 35, 40, 45, and 50) have been obtained, the intermediate tooth arrangements and the target tooth arrangement included in each tooth arrangement set may also be shown to the user. For example, for the orthodontic treatment step parameter equal to 5, 4 intermediate tooth arrangements and the target tooth arrangement in the corresponding tooth arrangement set may be shown, instead of only showing the target tooth arrangement. Similarly, for the orthodontic treatment step parameter equal to 50, 49 intermediate tooth arrangements and the target tooth arrangement in the corresponding tooth arrangement set may be shown, instead of only showing the target tooth arrangement. In this way, the user can select a tooth arrangement set that is optimal based on a balanced consideration of the intermediate tooth arrangements and the target tooth arrangement. Herein the balanced consideration indicates a full consideration of the intermediate tooth arrangements and the target tooth arrangement. Further, the user may select a tooth arrangement set based on a full consideration of the intermediate tooth arrangements, the target tooth arrangement and the orthodontic treatment step parameter, which is not repeated here.

It would be readily appreciated that the above selection may also be executed automatically by a computer. For example, the computer may automatically select the best tooth arrangement set based on digital image processing/matching methods.

Therefore, based on the aforementioned method for determining a tooth arrangement, when an initial position and medical rules (including medical parameters and orthodontic treatment constraints) are given, a series of tooth arrangements are simultaneously calculated by fixing the number of orthodontic treatment steps. It may be possible to calculate both the target tooth arrangement and all intermediate tooth arrangements when the number of orthodontic treatment steps is fixed, and it may also be possible to calculate only all intermediate tooth arrangements when the number of orthodontic treatment steps is fixed. The above methods all fall into the scope of the present disclosure and will not be repeated.

Moreover, when a certain number of orthodontic treatment steps is given, the calculation of the target position is modeled as a multi-objective optimization problem. The multiple objects include rules such as appearance, medical structures and functions, treatment tools and techniques, etc. In particular, it may include rules for satisfying the requirements of the appearance and medical structures (for example, the “alignment with the target curve of dental arch” rule and the “no gap between two teeth” rule), as well as constraints (for example, the movement at each step should be less than certain amount) encountered by the orthodontic treatment techniques.

Finally, when a group of tooth arrangement set corresponding to each orthodontic treatment step is obtained, a curve indicating the correspondence between the target position function and the number of orthodontic treatment steps is shown by a computer. Based on the curve, a user (including a physician, a technician, an operator or a user) may visually select the best target position and its corresponding number of steps so that it makes the treatment scheme more reasonable.

The method executed in steps S100-S140 may be implemented in a computer readable medium and executed by, for example, computer software, hardware or their combination. As to the hardware implementation, the embodiments described herein may be implemented in one or more components of Application Specific Integrated Circuits (ASIC), Digital Signal Processors (DSP), Digital Signal Processing Devices (DSPD), Programmable Logic Devices (PLD), Field Programmable Gate Arrays (FPGA), processors, controllers, micro controllers, microprocessors, or other electronic elements designated to execute the functions described herein or other alternative combinations.

As to the software implementation, the embodiments described herein may be implemented by a single software module such as a procedure and function, each of which executes one or more functions and operations described herein. Software codes may be implemented by a software application coded by any suitable programming language and may be stored in a computer specific storage or other computer readable medium and executed by a processor of a computer system. It may also be installed in any other electronic devices having data storage and processing functions, for example, a tablet computer with a touch screen, a smart mobile device, etc.

In order to realize interactive operations with a user such as a physician, the computer system in the present disclosure also includes a display device for displaying information to the user and an input device which enables the user to provide input to the computer system. Commonly used input devices include a mouse, a keyboard, a touch screen and a voice input device, or other types of user input devices.

Moreover, the computer system is programmed to provide a graphical user interface (GUI) and a three dimensional display interface to facilitate a user to set parameters by a computer system and select the best tooth arrangement set.

Further, when the best tooth arrangement set is obtained by the computer-implemented automatic tooth alignment process, the best tooth arrangement set may be used to manufacture the dental appliance.

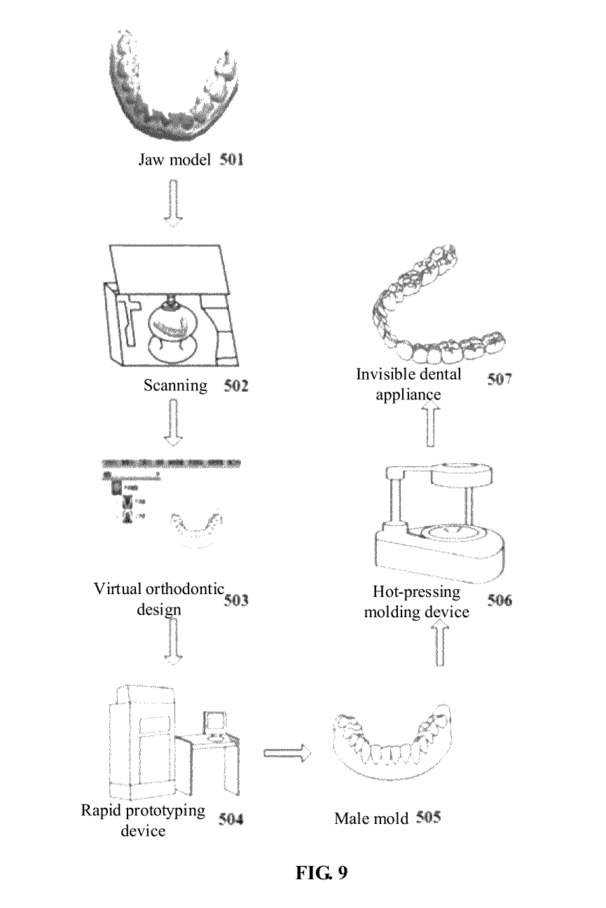

FIG. 9 illustrates an exemplary process of manufacturing an invisible dental appliance according to the present disclosure. For example, in step 501 a physical dental model is made based on a patient's initial tooth arrangement (for example, a plaster dental model is made by impression-taking method). Then in step 502, the physical dental model is scanned to generate a virtual tooth arrangement. A digital model that represents the initial tooth arrangement may also be obtained directly by optical scanning, three-dimensional photographing, three-dimensional imaging or medical CT scanning. The digital dental model may be digitized and displayed.

Next, for example, in step 503, the digital dental model is processed by the steps illustrated in FIG. 1 to generate the best tooth arrangement set and determine a practical orthodontic treatment scheme.

When the orthodontic treatment scheme is determined, in step 504 data of the corresponding target tooth arrangement is transmitted to a rapid prototyping device. Moreover, according to another embodiment of the present disclosure, when the digital models of the best tooth arrangement set are obtained, the method may further include: a post-processing step for processing the digital models of the best tooth arrangement set, which is prior to step 504. The post-processing step is executed by a computer to append one or more of the following: digital attachments, digital undercuts and digital labels. That is, in order to further optimize the obtained best digital models of the tooth arrangement set, the post-processing step may be executed by a computer. Then the processed digital models that represent the best tooth arrangement set are transmitted to a rapid prototyping device.

Specifically, data transmission may be implemented via memory devices such as a floppy disk, a hard disk, a compact disc, a memory card, a flash memory, and the data may also be transmitted to the rapid prototyping device via a wired or a wireless network connection. In step 505, the rapid prototyping may manufacture male molds (positive models) based on the digital models of the tooth arrangements. Alternatively, a numerical control machine may also be used to manufacture the male molds made of polymer, metal, ceramics or plaster based on the digital models of the tooth arrangements. When the male molds are generated, in step 506, a hot-pressing molding device may be used to hot-press the dental appliance subma made of a transparent high molecular material (for example, high molecular polymer material) on the male mold. Then a polishing and a finishing process is carried out to obtain the invisible dental appliance (step 507).

The manufacturing procedure illustrated in FIG. 9 is only exemplary, and variations may be made by an artisan in the art. For example, a female mold (negative model) may also be made based on the data of the target tooth arrangement (i.e., data of the orthodontic appliance), and then the rapid prototyping process is used to obtain the invisible dental appliance with a corresponding shape based on the obtained data of the orthodontic appliance.

Therefore, a digital model of an inner surface of the dental appliance that generally “matches” with an outer contour of the target tooth arrangement by offsetting about 0.05 mm or more from the crown surface of each tooth, using a conventional computer data processing method such as a computer aided design (CAD) method, based on the data of the target tooth arrangement. In particular, basic digital data representing the geometrical shape of the inner surface of the cavity of the dental appliance may be obtained based on the digital model that represents the target tooth arrangement. Further, the thickness of the dental appliance is determined. For example, the thickness of the dental appliance may be set to be 0.3-0.6 mm, which may vary depending on different materials and patient's requirements.

Further, the data of the dental appliance may be used as source data of the rapid prototyping device (for example, a three-dimensional printer). Macromolecular materials may be used by the rapid prototyping device to directly manufacture the three-dimensional dental appliance by using layered printing technology.

While various embodiments of the disclosed method and apparatus have been described above, it should be understood that they have been presented by way of example only, and not of limitation. The scope and spirit of the present disclosure is defined by the amended claims.

Similarly, various diagrams may depict an exemplary architecture or other configuration for the disclosed method and apparatus, which may help to understand the features and functionality that can be included in the disclosed method and apparatus. The claimed invention is not limited to the illustrated exemplary architectures or configurations, and the desired features can be implemented using a variety of alternative architectures and configurations. Moreover, with regard to the flow charts, operational descriptions and method claims, the order in which the blocks are presented herein shall not mandate that various embodiments be implemented to perform the recited functionality in the same order unless the context dictates otherwise.

Unless otherwise specified herein, terms, phrases and variations thereof shall be construed as open-ended rather than limiting. In certain examples, using terms, phrases or the like such as “one or more”, “at least”, “but not limited to”, etc. shall not be construed as an intention or requirement to narrow the scope of examples without such terms or phrases.

We claim:

1. A method for generating tooth arrangements, the method comprising:
receiving a digital model representing an initial tooth arrangement;
determining K orthodontic treatment step parameters, wherein the orthodontic treatment step parameters represent the number of orthodontic treatment steps for moving the initial tooth arrangement to an expected tooth arrangement, and K is an integer greater than or equal to 1;
for each orthodontic treatment step parameter, generating a group of digital models representing a tooth arrangement set corresponding to the orthodontic treatment step parameter, thereby obtaining K groups of digital models; and
selecting one group from the K groups of digital models that represents a best tooth arrangement set.

2. The method of claim 1, wherein each tooth arrangement set corresponding to an orthodontic treatment step parameter includes a target tooth arrangement and a plurality of intermediate tooth arrangements progressively changing into the target tooth arrangement, and the number of the plurality of intermediate tooth arrangements included in each tooth arrangement set is determined by the corresponding orthodontic treatment step parameter.

3. The method of claim 1, wherein each tooth arrangement set corresponding to an orthodontic treatment step parameter includes a plurality of intermediate tooth arrangements progressively changing into the target tooth arrangement, and the number of the plurality of intermediate tooth arrangements included in each tooth arrangement set is determined by the corresponding orthodontic treatment step parameter.

4. The method of claim 1, wherein for each orthodontic treatment step parameter, the digital models representing the tooth arrangement set corresponding to the orthodontic treatment step parameter are generated based on a multi-objective optimization model.

5. The method of claim 4, wherein the digital models representing the tooth arrangement set corresponding to the orthodontic treatment step parameter are generated by converting the multi-objective optimization model into a single-objective optimization model.

6. The method of claim 4, wherein the multi-objective optimization model is created based on one or more selected from the following medical parameters: curve of dental arch, degree of dental crowding, amount of interproximal reduction, overjet, overbite, dental arch convexity, depth of curve of Spee, Bolton ratio, dental arch width, arch symmetry, degree of tooth torsion, angulation of crown, torque, midline and profile of facial soft issue.

7. The method of claim 6, wherein the multi-objective optimization model is created based on one or more selected from the following orthodontic treatment constraints: direction and amount of tooth movement in each orthodontic treatment step, a sum of tooth forces in each orthodontic treatment step, limitation on freedom of tooth movements and requirements for avoiding teeth collision.

8. The method of claim 7, wherein the orthodontic treatment constraints comprise an inequality constraint and an equality constraint.

9. The method of claim 4, further comprising: calculating an optimal solution to an objective function of the tooth arrangement set corresponding to each orthodontic treatment step parameter using a global optimization algorithm to generate the digital model representing the tooth arrangement set corresponding to the orthodontic treatment step parameter.

10. The method of claim 9, wherein the global optimization algorithm comprises a simulated annealing algorithm.

11. The method of claim 9, wherein for each orthodontic treatment step parameter, the optimal solution to the objective function calculated using the global optimization algorithm is determined as an objective function value corresponding to the orthodontic treatment step parameter.

12. The method of claim 11, further comprising: generating a graph that represents a correspondence between the determined objective function value and the orthodontic treatment step parameter.

13. The method of claim 12, further comprising: presenting the graph to a user such that the user can choose the best tooth arrangement set based on the graph.

14. The method of claim 13, wherein the graph is a curve graph, and the method further comprises: calculating an inflection point of the curve graph and determining a tooth arrangement set corresponding to the inflection point as the best tooth arrangement set.

15. The method of claim 2, further comprising: after obtaining the K groups of digital models, presenting to a user an image of the target tooth arrangement included in each tooth arrangement set.

16. The method of claim 2, further comprising: after obtaining the K groups of digital models, presenting to a user an image of the intermediate tooth arrangements and target tooth arrangement included in each tooth arrangement set.

17. The method of claim 15, wherein a tooth arrangement set having an optimal target tooth arrangement is chosen as the best tooth arrangement set.

18. The method of claim 15, wherein a tooth arrangement set that is optimal based on a balanced consideration of the target tooth arrangement and orthodontic treatment step parameter is chosen as the best tooth arrangement set.

19. The method of claim 16, wherein a tooth arrangement set that is optimal based on a balanced consideration of the intermediate tooth arrangements and target tooth arrangement is chosen as the best tooth arrangement set.

20. The method of claim 16, wherein a tooth arrangement set that is optimal based on a balanced consideration of the intermediate tooth arrangements, target tooth arrangement and orthodontic treatment step parameter is chosen as the best tooth arrangement set.

21. The method of claim 17, wherein the best tooth arrangement is chosen by a user.

22. The method of claim 17, wherein the best tooth arrangement is chosen by a computer.

23. A method for manufacturing dental appliances, the method comprising: obtaining the best tooth arrangement set for a patient according to the method of claim 1, and manufacturing the dental appliances using digital models of the best tooth arrangement set.

24. The method of claim 23, wherein after obtaining the digital models of the best tooth arrangement set, the method further comprises:
executing a post-processing step for the digital models of the best tooth arrangement set to append one or more of the following: a digital attachment, a digital undercut and a digital label.

25. The method of claim 23, wherein the digital models of the best tooth arrangement set are transmitted to a dental appliance manufacturing device, and the dental appliance manufacturing device utilizes the digital models to generate male molds for manufacturing dental appliances having corresponding shapes.

26. The method of claim 25, wherein the male molds are generated by the dental appliance manufacturing device using a rapid prototyping process.

27. The method of claim 23, wherein digital models of the dental appliances are determined based on the digital models of the best tooth arrangement set, and the digital models of the dental appliances are transmitted to a dental appliance manufacturing device, and the dental appliances are directly manufactured by the dental appliance manufacturing device based on the digital models of the dental appliances.

28. The method of claim 27, wherein the dental appliances are manufactured using a rapid prototyping process.

29. A dental appliance manufactured by the method of claim 23.

30. The dental appliance of claim 29, wherein the dental appliance is made of a flexible macromolecular material.

31. The dental appliance of claim 30, wherein the macromolecular material is transparent.

32. The dental appliance of claim 30, wherein the macromolecular material is a macromolecular polymer material.
